(19) United States
(12) Patent Application Publication
(10) Pub. No.: US 2012/0081299 A1
(43) Pub. Date: Apr. 5, 2012

(54) METHOD AND APPARATUS FOR PROVIDING REMOTE CONTROL VIA A TOUCHABLE DISPLAY

(75) Inventors: Hong Xiao, Acton, MA (US); Afshin Moshrefi, Newburyport, MA (US); Rahul Khushoo, Waltham, MA (US); Dongchen Wang, Concord, MA (US)

(73) Assignee: VERIZON PATENT AND LICENSING INC., Basking Ridge, NJ (US)

(21) Appl. No.: 12/897,421

(22) Filed: Oct. 4, 2010

(51) Int. Cl. G06F 3/041

(52) U.S. Cl. 345/173

(57) ABSTRACT

An approach is provided for controlling a display of a set-top box from a remote control device having a touchable display. User input is received via the touchable display of the remote control device. A control signal is generated in response to the user input for controlling a set-top box coupled to a display. The set-top box is configured to present the content on the display concurrently with the touchable display.

### BACKGROUND INFORMATION

With the advancement of television displays as well as increased sophistication of content ranging from traditional broadcast television programs and Internet-based content, the design of user interfaces impose a continual challenge for manufacturers to balance convenience and functionality. One area of development in television technology involves providing touchable displays for user interaction and selection of content. Touch based televisions feature displays that are configured with various sensors for recognizing a user's physical touch and associating the movement or pattern made by the user with a particular command for controlling the television (TV). For example, a user may tap the display to invoke a TV control panel, click on a link presented during a broadcast to retrieve additional content or make a leftward or rightward motion on the display to toggle between stations. In short, touchable displays enable users to interact with the TV and content directly while providing an alternative to manual or remote control mechanisms. Unfortunately, although touchable displays promote efficient user interaction, these displays require user proximity to the television. In effect, this efficiency is lost when the display is outside the physical reach of the touchable display.

Therefore, there is a need for an approach that provides flexible, efficient techniques for enabling control of content over a display, particularly a touchable display.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of enabling a user to interact with and control a content processing device (e.g., set-top box) using a device with a touchable display, according to an exemplary embodiment;

FIG. 2 is a diagram of a content processing device and remote control device having a touchable display to enable control of the content processing device, according to an exemplary embodiment;

FIG. 3 is a flowchart of a process for generating a control signal at a remote control device having a touchable display for enabling interaction and control of a content processing device, according to an exemplary embodiment;

FIGS. 4A and 4B are flowcharts of processes for enabling presentment of content to a display of a content processing device based on input from a remote control device having a touchable display, according to an exemplary embodiment;

FIGS. 5-8 are diagrams of a display for enabling presentment of content based on input from a remote control device featuring a touchable display, according to an exemplary embodiment;

FIG. 9 is a diagram of a computer system that can be used to implement various exemplary embodiments; and

FIG. 10 is a diagram of a chip set that can be used to implement various exemplary embodiments.

### DESCRIPTION OF THE PREFERRED EMBODIMENT

A preferred apparatus, method, and software for enabling a user to interact with and control a content processing device are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a content processing device such as a set-top box (STB), it is contemplated these embodiments have applicability to any device capable of processing content (e.g., audio/video (AV)) signals for presentation to a user, such as a home communication terminal (HCT), a digital home communication terminal (DHCT), a stand-alone personal video recorder (PVR), a television set, a digital video disc (DVD) player, a video-enabled phone, an audio/video-enabled personal digital assistant (PDA), and/or a personal computer (PC), as well as other like technologies and customer premises equipment (CPE).

In addition, though various exemplary embodiments are described with respect to a mobile device, it is contemplated that these embodiments have applicability to any device configured with a touch display and the appropriate hardware and software for transmitting wireless signals, such as smartphones, cellular phones, wireless enabled personal computing (PC) devices, tablet PCs (e.g., iPads), personal data assistants, as well as other like technologies.

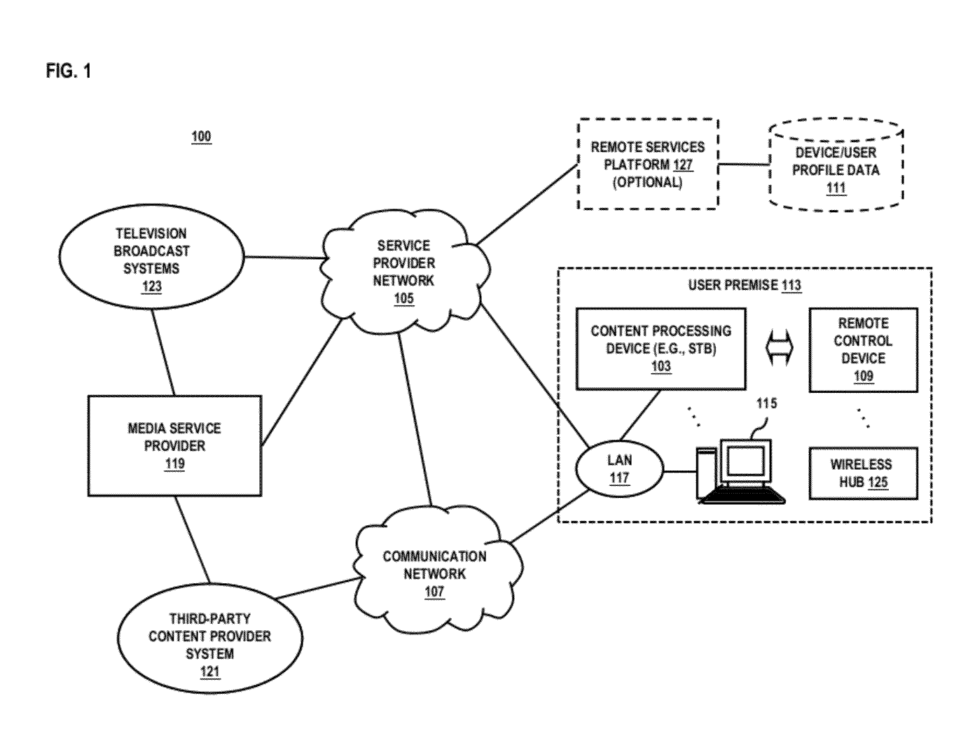

FIG. 1 is a diagram of a system capable of enabling a user to interact with and control a content processing device (e.g., set-top box) using a device with a touchable display, according to an exemplary embodiment. For the purposes of illustration, system 100 is described with respect to interaction between a remote control device 109 configured to interface with content processing devices (e.g., set-top boxes (STBs)) 103 via wireless communication means. Communication between the remote control device 109, configured as a wireless communication device having a touchable display, and the content processing device 103, may be facilitated through a service provider network 105 and/or communication network 107. System 100 may be configured to support full scale control of content processing devices using well known wireless communication devices having touchable displays. While specific reference will be made hereto, it is contemplated that system 100 may embody many forms and include multiple and/or alternative components and facilities. Further, it is also contemplated that a content processing device may be integrated with the display itself, according to one embodiment.

In certain embodiments, a “touchable display” or “touch screen” pertains to any device (e.g., remote control device 109) configured with an interface and one or more sensors, detection systems and the like for detecting touch signals applied to the interface. Generally, “touch signals” or “touch” is input applied directly to the interface by a user's finger, a stylus, a pen or any other object for applying an amount of pressure and/or contact directly to the touchable display. This approach to data input contrasts with traditional peripheral or integrated data entry means, including push-button systems, keypads and keyboards. Various types of devices may feature touchable displays, including mobile devices, PDAs, tablet PCs, laptops and the like. Still further, many appliances and other industrial machinery may be configured with touchable displays, particularly for providing user-friendly control panels of said devices, including televisions, video recorders and players (e.g., digital video recorders (DVRs)), alarm clocks, home entertainment systems, kitchen appliances such as (e.g., refrigerators, dishwashers), copy machines, printers and manufacturing equipment. In some configurations, devices may feature a touchable display as well as push-button data entry means.

It is noted that in addition to perceiving touch signals, a touchable display may also be configured to detect pattern or motion characteristics associated with a touch. For the purpose of illustration, the term “touch signal” or “touch” is meant to include any touch, motion, speed or pattern signals generated by way of contact with the device interface, including single or multiple touch input. In certain embodiments, the touchable display operates in connection with motion or touch detection and recognition systems (e.g., sensors, software), whereby the touch signals are received at the interface as input data and interpreted to determine their meaning or purpose. Depending on the operating system or functions of the device configured with the touchable display, touch may correspond to varying commands for enabling device software or hardware actions. This may include tapping an icon as presented to the interface (touchable display) for activating a particular software feature, performing an upward or downward swiping motion across the display for scrolling through a document, drawing a character on the display for transcription to its textual representation, moving the stylus across the display at a certain pace for controlling the rate of rewind of media content (e.g., audio or video data), etc. For illustrative purposes, the touchable display is meant to include the software, firmware and/or various sensors (e.g., motion, pattern, touch, tilt, speed) required for effectively receiving and interpreting touch to purposefully trigger a device or software control function.

It is observed that television remains the prevalent global medium for entertainment and information as individuals spend a great deal of time tuning into televised and broadcast media. With the introduction of the DVR, for example, consumers are able to record content, such as televised media, to a memory medium so that the content may be accessed at a later time. In addition, home entertainment systems nowadays have been developed for integrating traditional media access and playing systems, including integrating video players (e.g., DVR) with internet access mediums and music players. As the sophistication of content processing devices, home entertainment systems and the like continues to advance in terms of control and media integration, the display characteristics are just as critical to the user experience. Consequently, today's devices feature high definition television (HDTV) technology, flat panel displays, liquid crystal displays (LCDs) and other display implementations catered towards enhancing picture quality, clarity and robustness. Some devices are even equipped with touchable displays for enhancing user interaction with content presented to the display and control of the device.

It is recognized that remote control technology has not kept pace with the advancements in display technology or set-top box (STB) developments. Traditional remote control devices provide simple controls (typically hard buttons and key pads) for selection of channels and commands such as volume, video input, etc. As dedicated controllers, lack of access to the remote forces users to resort to manual control of the STB or display, which in turn diminishes the overall user experience. Thus, the approach of system 100, according to certain embodiments, stems from the recognition that consumers can benefit from the ability to control and interact with a content processing device using a remote control device having a touchable display. By way of this approach, content presented to a remote control device 109 may be concurrent with that featured on the display of the content processing device 103. Instances of touch at the remote control device 109 correspond to a touch at the content processing device 103 for controlling the device and interacting with content. Hence, touch signals engaged at the touchable display of the remote control device 109 are realized as if they were performed directly at the touchable display of the content processing device 103 (e.g., set-top box). Alternatively, non-touchable displays can effectively gain the advantages of a touchable display via the interaction between the remote control device 109 and the set-top box 103.

As shown, system 100 includes remote control device 109 that may be configured to generate control signals for managing, controlling and enabling interaction with the content processing device 103 and/or content displayed thereon. Operation of the remote control device 109 for generating control signals is facilitated through use of a touchable display of the remote control device 109. The remote control device 109 is further configured to a wireless hub 125 of which the content processing device 103 is mutually configured. By way of example, the wireless hub 125 is implemented as hardware and/or software for generating a wireless communication link/local area network (LAN) 117 through which respective devices in a user premise 113 may communicate relative to a subscription with a service provider 105 or communication network 107. It is noted in certain instances, a computing device 115 may also be configured mutually to the LAN 117 and content processing device 103 for enabling integration of computing controls via the STB 103.

In certain embodiments, control signals generated in response to touch at the remote control device 109 may be transmitted to the content processing device via the LAN 117 generated by the wireless hub 125. Alternatively, the control signals may be generated as wireless signals that are generated or packaged based on proximity and short range communication protocols, including Bluetooth or infrared. In this alternative approach, the remote control device 109 may readily contact and interact with the content processing device 103 with or without the wireless hub 125. In both instances, the content processing device 103 may feature configuration settings for permitting it to be controlled by the remote control device. This may be carried out through a permission process, wherein the user enables activation or a relationship between the devices as they detect one another, through a LAN configuration process, a signal exchange process between the remote control device 109 and the content processing device 103 (e.g., for programming the remote control device relative to the STB 10e), etc. It is noted in the various embodiments that any means of wireless communication between the content processing device 103 and remote control device 109 is applicable. Resultantly, any developing or well known protocols for facilitating wireless communication relative to the various devices 103, 115 and 109 configured to the LAN 117 may be implemented.

By way of example, content processing device 103 and/or computing device 115 may be configured to communicate using one or more of networks 105 and 107. System 107 can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G wireless broadband networks, mobile television networks, radio networks, etc.), terrestrial broadcasting networks, provider specific networks (e.g., fiber optic networks, cable networks, etc), and the like. Such networks may also utilize any suitable protocol supportive of data communications, e.g., transmission control protocol (TCP), internet protocol (IP), file transfer protocol (FTP), telnet, hypertext transfer protocol (HTTP), hypertext transfer protocol secure (HTTPS), asynchronous transfer mode (ATM), socket connections, Ethernet, frame relay, and the like, to connect content processing devices 103 to various sources of media content, such as one or more third-party content provider systems 121. Although depicted in FIG. 1 as separate networks, communication network 107 may be completely or partially contained within service provider network 105. For example, service provider network 105 may include facilities to provide for transport of packet-based communications.

According to certain embodiments, content processing devices 103 and/or computing devices 115 may be configured to communicate over one or more local area networks (LANs) corresponding to user premises 113a-113n. In this manner, routers (e.g., wireless hub 125) may be used for establishing and operating, or at least connecting to, a network such as a “home” network or LAN 117, and is used to route communications within user premises 113a-113n. For example, content processing device 103 may be a set-top box communicatively coupled to LAN 117 via a router and a coaxial cable, whereas computing devices 115 may be connected to LAN 117 via a router and a wireless connection, a network cable (e.g., Ethernet cable), and/or the like. It is noted, however, that in certain embodiments content processing device 103 may be configured to establish connectivity with LAN 117 via one or more wireless connections. Further, content processing device 103 and computing device 115 may be uniquely identified by LAN 117 via any suitable addressing scheme. For example, LAN 117 may utilize the dynamic host configuration protocol (DHCP) to dynamically assign “private” DHCP internet protocol (IP) addresses to content processing device 103 and computing devices 115, i.e., IP addresses that are accessible to devices such as devices 103 and 115 that are part of LAN 117 facilitated via router, i.e., connected to a router.

Accordingly, it is noted that user premises 113 may be geospatially associated with one or more regions, one or more user profiles and one or more user accounts. This information may include content or user profile information among many other things. Additionally, content processing devices 103 associated with the user premises 113 may be configured to communicate with and receive signals and/or data streams from media service provider (MSP) 119 or other transmission facility, i.e., third-party content provider system 121. These signals may include media content retrieved over a data network (e.g., service provider network 105 and/or communication network 107), as well as conventional video broadcast content. In various embodiments, media content broadly includes any audio-visual content (e.g., broadcast television programs, VOD programs, pay-per-view programs, IPTV feeds, DVD related content, etc.), pre-recorded media content, data communication services content (e.g., commercials, advertisements, videos, movies, songs, images, sounds, etc.), Internet services content (streamed audio, video, or image media), and/or any other equivalent media form. In this manner, MSP 119 may provide (in addition to their own media content) content obtained from sources, such as one or more third-party content provider systems 121, one or more television broadcast systems 123, etc., as well as content available via one or more communication networks 107, etc.

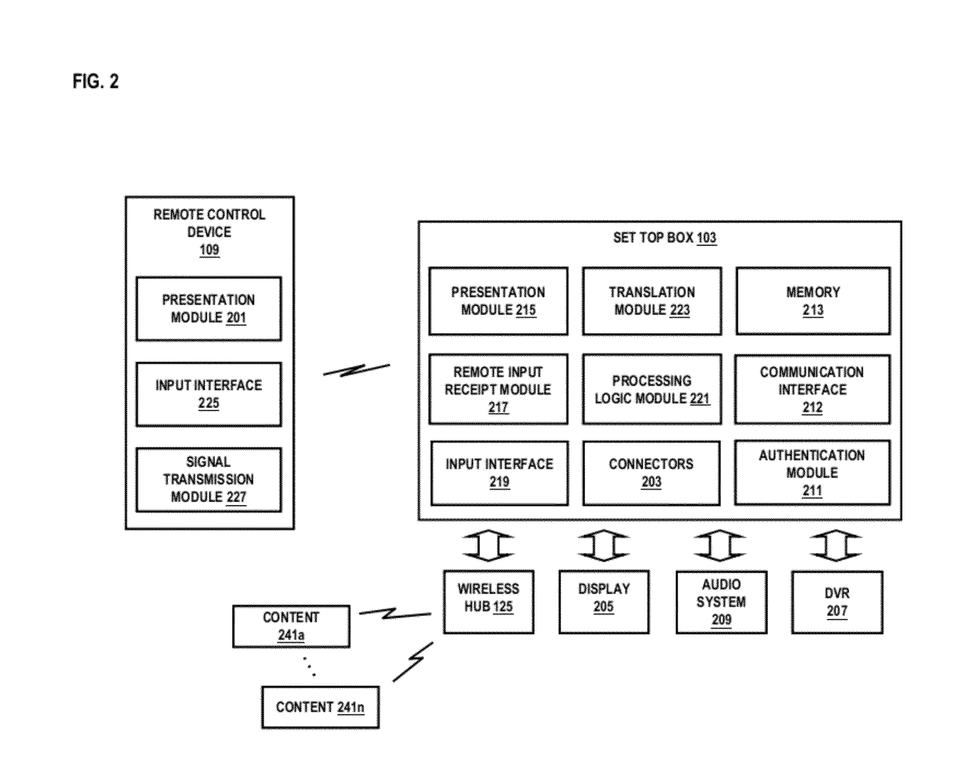

FIG. 2 is a diagram of a content processing device and remote control device having a touchable display to enable control of the content processing device, according to an exemplary embodiment. STB 103 comprises a control architecture featuring a collection of modules that interact to enable specific functions. In addition, the STB 103 may include various other operating system and dynamic controls (not shown) conforming to its manufacture, display characteristics, etc. By way of example, content processing device 103 may comprise any suitable technology to receive one or more content streams from a media source, such as MSP 119 and one or more third-party content provider systems 121. The content streams include media content 241a-241n retrieved over one or more data networks (e.g., networks 105 and/or 107), as configured via a wireless hub 125 (e.g., router), in response to commands from one or more media applications.

According to various embodiments, content processing device 103 (e.g., STB) may also include inputs/outputs (e.g., connectors 203) to display 205 and DVR 207, the wireless hub 125 and audio system 209. By way of example, audio system 209 may comprise a conventional audio-video receiver capable of monaural or stereo sound, as well as multi-channel surround sound. Audio system 209 may include speakers, ear buds, headphones, or any other suitable component configured for personal or public dissemination. As such, content processing device 103, display 205, DVR 207, and audio system 209, for example, may support high resolution audio and/or video streams, such as high definition television (HDTV) or digital theater system high definition (DTS-HD) audio. Thus, content processing device 103 may be configured to encapsulate data into a proper format with required credentials before transmitting onto one or more of the networks of FIG. 1 and de-encapsulate incoming traffic to dispatch data to display 205 and/or audio system 209.

In various embodiments, the content processing device 103 may also permit the embedding or overlay of additional content (e.g., messages, captions, advertisements) 241a-241b for presentment along with any broadcasted or televised content rendered to the display 905. Various built in menus, information frames and content windows, referred as widgets, may be provided by the media service provider 119 or the like for presentment along with media content, as rendered by a presentation module 215. Certain widgets may also feature interactive buttons that may be controlled by the user. An example of such a widget is a channel guide that features the various shows and show times available to the user, featuring an arrow button for moving between pages of the guide. In certain instances also, “interactive content” may be include with media content to render items capable of activation, such as to invoke other features. By way of example, a user of a STB 103 configured with a touchable display 205 may allow a user to touch specific items of content presented during a televised broadcast, i.e., the get-away car driven by the hero during a certain scene of a movie. This interactive content can then be used to trigger invocation of a widget, application, web service or other executions associated with the content, including an information widget for presenting details about the interactive content selected, an email-editor for sending a message to a manufacture or seller of the item, a virtual catalogue featuring additional or related items, an advertisement widget pertaining to the item selected, a biography widget for indicating details of a selected actor or actresses' career or any other executable widget.

In certain embodiments, display 205 and/or audio system 209 may be configured with internet protocol (IP) capability (i.e., includes an IP stack, or is otherwise network addressable), such that the functions of content processing device 103 may be assumed by display 205 and/or audio system 209. In this manner, an IP ready, HDTV display or DTS-HD audio system may be directly connected to one or more service provider networks 105 and/or communication networks 107. Although content processing device 103, display 205, DVR 207 and audio system 209 are shown separately, it is contemplated that these components may be integrated into a single component or other combination of components.

In one embodiment, an authentication module 211 may be provided by content processing device 103 to initiate or respond to authentication schemes of, for instance, service provider network 105, third-party content provider systems 121, or various other content providers, e.g., television broadcast systems 123, etc. Authentication module 211 may provide sufficient authentication information, e.g., a user name and password, a key access number, a unique machine identifier (e.g., MAC address), and the like, as well as combinations thereof, to a corresponding communications (or network) interface 212 for establishing connectivity, via LAN 117, and to seamless viewing platform 201. Authentication at content processing device 103 may identify and authenticate a second device (e.g., computing device 115) communicatively coupled to, or associated with, content processing device 103, or vice versa. Further, authentication information may be stored locally at memory 213, in a repository (not shown) connected to content processing device 103 or at a remote repository (e.g., device or user profile repository 111).

Authentication module 211 may also facilitate the reception of data from single or disparate sources. For instance, content processing device 103 may receive broadcast video from a first source (e.g., MSP 119), signals from a media application at second source (e.g., computing device 115), and a media content stream from a third source accessible over communication networks 107 (e.g., third-party content provider system 121). As such, display 205 may present the broadcast video, media application, and media content stream to the user, wherein content processing device 103 (in conjunction with one or more media applications) can permit users to experience various sources of media content traditionally limited to the data domains. This presentation may be experienced separately, concurrently, in a toggled fashion, or with zooming, maximizing, minimizing, or trick capabilities, or equivalent mode. In other exemplary embodiments, authentication module 211 can authenticate a user to allow them to interact with one or more third-party subscriber account features associated with third-party content provider systems 121.

In one embodiment, presentation module 215 may be configured to receive media content streams 241a-241n (e.g., audio/video feed(s) including media content retrieved over a data network) and output a result via one or more connectors 203 to display 205 and/or audio system 209. In this manner, presentation module 215 may also provide a user interface for a media application via display 205. Aural aspects of media applications may be presented via audio system 209 and/or display 205. In certain embodiments, media applications, such as media manager 201, may be overlaid on the video content output 207 of display 205 via presentation module 315. The media content streams 241a-241n may include content received in response to user input specifying media content 241a-241n that is accessible by way of one or more third party content provider systems 105 and, thereby, available over at least one data network (e.g., network 105 and/or 107), wherein the media content 241a-241n may be retrieved and streamed by content processing device 103 for presentation via display 205 and/or audio system 209. Accordingly, presentation module 215 may be configured to provide lists of search results and/or identifiers to users for selection of media content to be experienced. Exemplary search results and/or identifiers may include graphical elements, channels, aural notices, or any other signifier, such as a uniform resource locator (URL), phone number, serial number, registration number, MAC address, code, etc.

It is noted the presentation module 215 may enable presentment of widgets and other executables to the display 205, such as in connection with the media services provider 119. It is further noted that the presentation module 215 may be adapted by the user, such as for enabling creation of a customized graphical user interface (GUI) relative to the user. The GUI setup data can be maintained in the device and/or user profile 111 for enabling a customized viewing and device control experience. Under this scenario, the presentation (or presentment) module 215 offers the user various customization features for tailoring the content presentment capabilities of the interface to their liking (e.g., skin selection, button activation/deactivation, text features, etc.) or, for displays featuring touchable displays, enabling configuration of touch interface settings. Settings pertaining to the touchable display of the STB 103 may be presented to the user for adaptation via the presentation module 215. In the case of the both the customized GUI and the display interface settings, a local memory 213 for storing preferences affecting media content viewing and STB 103 control may be maintained in addition to or instead of device and/or user profile repository 111. Configuration of the touchable display 205, however, including sensor sensitivity level, custom touch signal inputs, etc., are configured through the input interface 219. The various functions and features of a touchable display as described above, including mechanisms for interpreting touch, are enabled by way of the input interface 219.

In one embodiment, a remote input receipt module 217 receives control signals generated by a remote control device 109. By way of example, the control signal may be received by the remote input receipt module 217 as touch data, where it is subsequently decoded and associated with its equivalent STB 103 or media interaction function by a processing logic module 221. As another example, the control signal may be received as STB 103 or media interaction control function data directly. In this example, no decoding of touch data or associating it with its equivalent user command need be performed (e.g., by the processing logic module 221) as such functions were performed accordingly by the remote control device 109. Regardless of the execution, both control signal receipt approaches enable a means of control over the STB 103 and interaction with media content 241a-241n via the remote control device 109. It is also noted that the remote input receipt module 217 may operate in a manner equivalent to the input interface 219, except the control signal for STB or content interaction (e.g., input data (touch)) is received via remote communication means as opposed to direct user contact with the display 205. Non-touchable displays can also be provided with the advantages of a touchable display via the interaction between the remote control device 109 (with its touchable display) and the set-top box 103.

In one embodiment, a translation module 223 operates in connection with the presentation module 215 to translate content, touch, position, speed and other data detected by way of a touchable display of the remote control device 109 into concurrent data relative to the display 205 of the STB 103. Alternatively, the translation module translates the control signal received from the remote control device based on touch and characteristic data thereof into concurrent data relative to the display 205. It is noted that the remote control device 109 and STB 103 can access the same content 241a-241n concurrently via network services provider 105 or communication network 107. However, the processing resources of the remote control device 109 and the STB 103 may differ as well as their respective display sizes relative to one another, i.e., by a proportion of 1:n. Hence, by way of example, the translation module 223 may apply a proportionality function for ensuring touch at a certain point on the display of the remote control device 109 corresponds to an equivalent point of touch on the STB display 205. Likewise, in instances where text or mouse cursor repositioning or movement is rendered to the display of the remote control device 109, an equivalent repositioning or movement is translated to the (larger) display 205. It is noted that the translation module 223 is useful for ensuring the adequate selection and activation of interactive content, widgets, control buttons and the like at the remote control device 109 is reproduced in a real-time, one-to-one fashion on the STB display 205. Furthermore, the translation module 223 may account for dissimilarity in processing speeds of the two devices to ensure greater concurrency of display refresh or scan rates.

Connector(s) 203 may provide various physical interfaces to display 205, audio system 209, as well as other peripherals; the physical interfaces may include, for example, RJ45, RJ11, high definition multimedia interface (HDMI), optical, coax, FireWire, wireless, and universal serial bus (USB), or any other suitable connector. Regardless of the connection medium, the STB 103 may be induced by the remote control device 109 to enable user control over the various features of the STB or media content 241a-241b displayed thereon. In one embodiment, the remote control device 109 features a presentation module 215 for enabling presentment of media content 241a-241n and other features to the device display (not shown). Also, the remote control device 109 features an input interface 225 for enabling the various functions and features of a touchable display as described above, including mechanisms for interpreting touch. It is noted modules 201 and 225 are equivalent in function and/or implementation as modules 215 and 219 respectively of the STB 103, but adapted according to the operating system, sensor characteristics and other factors associated with the remote control device 109.

In one embodiment, a signal transmission module 227 generates and transmits control signals from the remote control device 109 for enabling the control over the STB 103 or interaction with content 241a-241n as it is presented to the display of both devices concurrently. By way of example, the signal transmission module 227 transmits touch data received as input at the touchable display to the remote input receipt module 217 of the STB, such as via a wireless communication session. As another example, the signal transmission module 227 generates a control signal conforming to a specific STB 103 or media interaction control function. It then transmits the control signal to the remote input receipt module 217 accordingly in this form.

It is noted that the remote control device 109 may be implemented as a wireless computing device such as a laptop or tablet PC, a mobile communication device such as a cell phone or smartphone, or any other wireless enabled device capable of rendering content to a touchable display. Generally, the remote control device 109 allows users to readily manipulate and dynamically modify parameters affecting the media content being viewed at the STB display 205. In other examples, the remote control device 109 may also include (not shown) a cursor controller, trackball, touch screen, touch pad, keyboard, and/or a key pad for enabling alternative means of controlling the STB and interacting with content 241a-241n. Of particular note, the remote control device 109 enables execution touch based controls needed for operation of the STB 103 and interaction with specific content displayed thereon for touchable and non-touchable displays.

In certain embodiments, an optional remote services platform 127 may be accessed by the remote control device 109 via the wireless hub 125/LAN 117, as depicted in FIGS. 1 and 2. The remote services platform 127 is implemented to feature a control architecture equivalent in implementation or function to that of STB 103 for enabling single or multiple touch at the remote control device 109 to translate into control functions of a STB 103. It is noted that the remote services platform 127 presents a medium for enabling STB 103 control and/or interaction with content displayed thereon when the STB 103 is not configured as in FIG. 2. By way of example, a television having a touchable or non-touchable display may be configured to the remote services platform 127 for enabling execution of the above described modules. The remote control device 109 then transmits control signals via the signal transmission module 227 to the remote services platform 127 instead of the STB 103. Upon receipt, the remote services platform 127 triggers the control functions of the STB 103 in response to signals received from the remote control device. As such, the remote services platform 127 acts as an intermediary device or service for enabling control of the STB 103 from the remote control device 109. As a service, the remote services platform is a middle layer software or network solution that provides a communication bridge between the remote capable mobile device 109 and the STB 103.

In one embodiment, the optional remote services platform 127 is also configured to maintain one or more device and/or user profiles 111 for managing the operation of respective content processing devices 103 and any integrated or peripheral systems thereof, i.e., DVR system, radio and other devices. By way of example, the user profile 111 may include data for referencing the user relative to a remote control device 109 of that user, including a radio-frequency identifier (RFID), an identification code, a subscriber identity module (SIM) or other machine-readable or detectable information. Also, the user profile may include data specifying the name, address, and other contact details of the user, as well as data representative of a level of association the user has with the premise 113 or respective content processing devices 103. By way of example, the user's specified address may be referenced against the address of the user premise 113 for determining a match. As another example, the user may be assigned an access or usage level of “owner” or “guest” for indicating the extent of interaction possible between the user and the platform 125 in addition to various security settings and features.

In addition, the device and/or user profile 111 may also indicate various content processing device configuration preferences, content, broadcast or programming preferences and features, and other characteristics for customizing the user content display and viewing experience. In this scenario, for example, one user associated with the user premise 113 may prefer that content be presented along with captions, while another user of the same premise 113 prefers their content to be presented without captions. By way of example, STB 103 configuration data can relate to monitor size, audio/video interface (e.g., High-Definition Multimedia Interface (HDMI)) setup, audio settings, time zone, network address settings, etc), programming guides (e.g., available channels, blocked and hidden channels settings, skin preferences, customizations, etc.) and personal recording settings (e.g., show names, times record types (e.g., all, single, series, latest), record channels, etc.)). Establishment of a device and/or user profile 111 may be performed upon initial setup and integration of the content processing device 103 within the user premise 113 or at a later time to enable configuration updates by a user.

It is noted the remote services platform 127 may access application programming interface (API) and operating system (OS) data pertinent to the specific STB, such as maintained in association with a user and/or device profile database 111. Consequently, multiple different STBs may be associated with a single user profile and controlled by a single remote control device 109 of the user. Still further, it is contemplated that the remote services platform 127 may be configured to STBs not equipped with a touchable display as a means of enabling touchable display capabilities via the remote control device 109. This includes enabling traditional remote control operations to be associated with their touch based control equivalent through use of a touchable remote control device 109. For the purpose of illustration, and not by way of limitation, the remote services platform 127 is to be taken as synonymous with the exemplary control architecture of STB 103 as presented; the architecture of the two being identical in function and/or implementation, but only varying in terms of external or internal configuration.

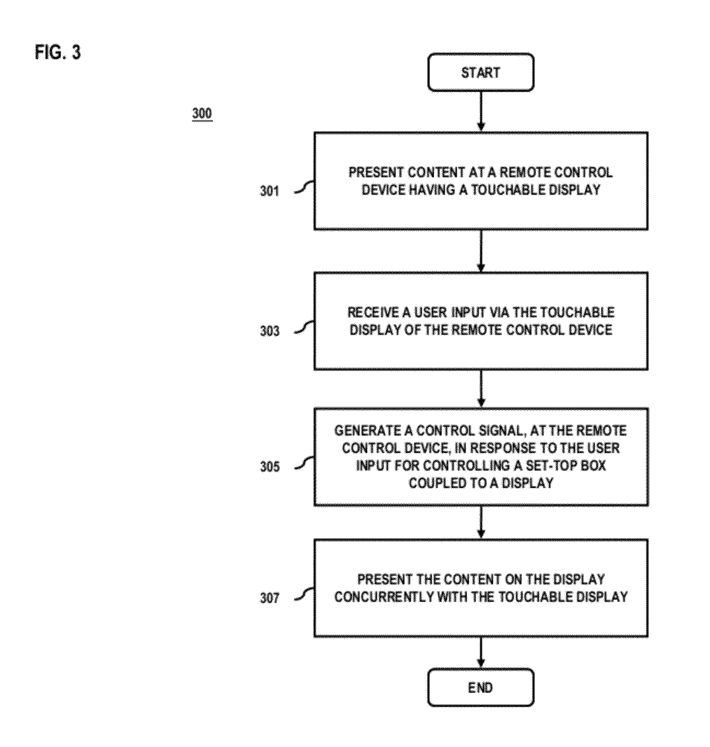

FIG. 3 is a flowchart of a process for generating a control signal at a remote control device having a touchable display for enabling interaction and control of a content processing device, according to an exemplary embodiment. For the purpose of illustration, the processes are described with respect to FIGS. 1 and 2. It is noted that the steps of process 300 may be performed in any suitable order, as well as combined or separated in any suitable manner. In step 301, content is presented at a remote control device 109 having a touchable display, such as by way of the presentation module 201. In step 303, the remote control device 109 receives a user input via the touchable display. A single or multiple touch may be provided to the display, where associated characteristics of the touch include its speed, pattern, motion, contact period, pressure, etc. Based on the touch and its associated characteristics, a control signal is generated at the remote control device 109, by way of the signal transmission module 227, corresponding to step 305. The signal is suitably generated for controlling a set-top box 103 coupled to a display 205 (e.g., touchable or non-touchable). In another step 307, the content on the touchable display of the remote control device 109 is presented concurrently with the display 205 of the STB 103.

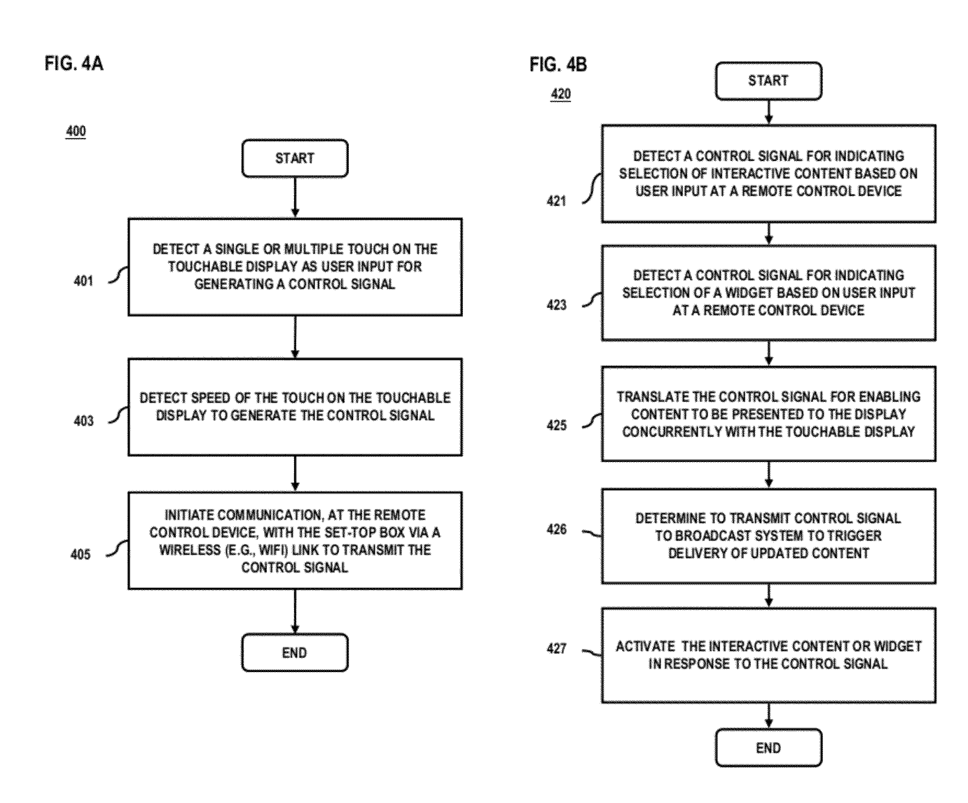

FIGS. 4A and 4B are flowcharts of processes for enabling presentment of content to a display of a content processing device based on input from a remote control device having a touchable display, according to an exemplary embodiment. For the purpose of illustration, the processes are described with respect to FIGS. 1 and 2. It is noted that the steps of processes 400 and 420 may be performed in any suitable order, as well as combined or separated in any suitable manner. In step 401 of process 400, the remote control device 109 detects a single or multiple touch on its touchable display as user input for generating a control signal. In step 403, the speed, motion, pattern and other characteristics of the touch input or combinations thereof are detected for generating the control signal. In another step 405, the signal transmission module 227 initiates communication with the set-top box via a wireless link in order to transmit the control signal. It is noted that the wireless link may occur by way of the LAN 117, a WiFi connection (e.g., implementation of a wireless LAN), a Bluetooth connection (e.g., implementation of a wireless personal area network (WPAN)), radio-frequency (RF) communication and the like. With respect to FIG. 4B, process 420 provides, per step 421, detection by the STB 103 (specifically, the remote input receipt module 217) of a control signal for indicating selection of interactive content based on user input at the remote control device. In step 423, a control signal for indicating selection of a widget based on user input at a control device is detected. Of note, in certain embodiments, one or the other of steps 421 and 423 are performed, depending on the control signal received. The translation module 223 translates the control signal for enabling content to be presented to display 205 of STB 103 concurrently with the touchable display of the remote control device 109, corresponding to step 425 of the procedure 420. The translation process, in one embodiment, may include transmitting the control signal to the TV broadcast system 123 to trigger delivery of updated content to the STB 101 from over the communication network 107. As such, the most up-to-date content is presented to the user. In another step 427, the interactive content or widget is activated in response to the control signal. The activation is based on the translation as performed by the translation module 223, wherein user enabled cursor, mouse, window or object movements resulting from touch at the touchable display is reproduced and rendered at the STB display 205.

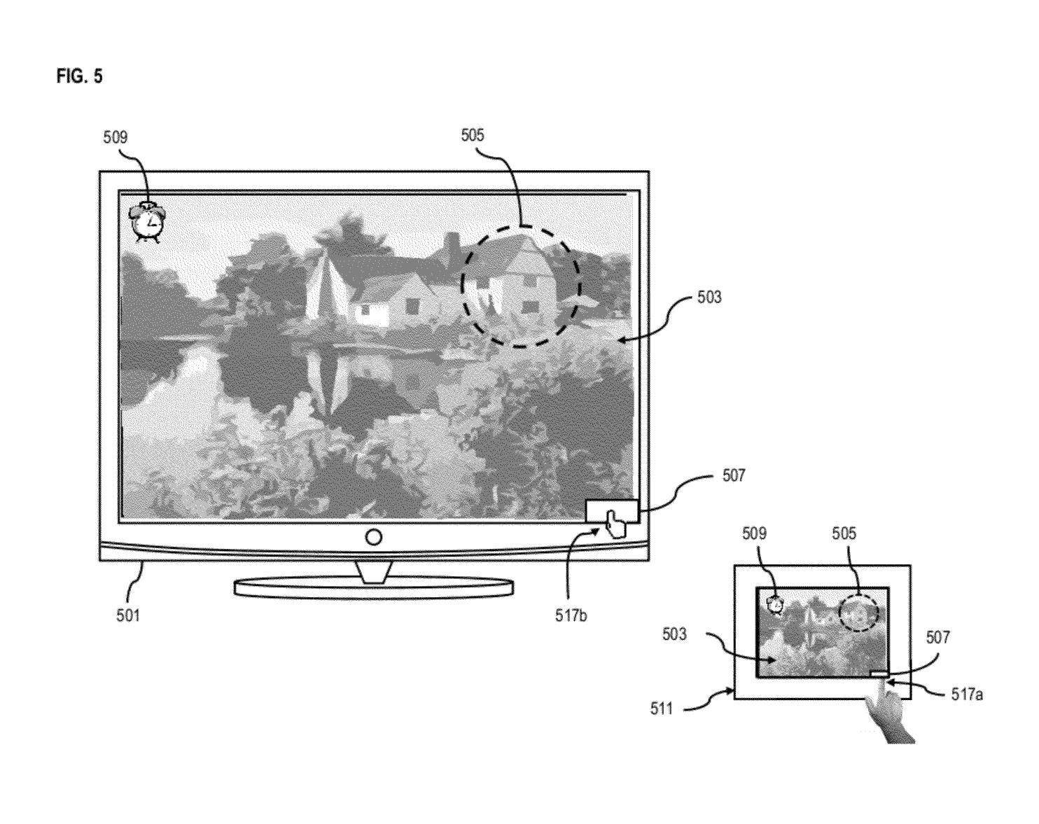

FIGS. 5-8 are diagrams of a display for enabling presentment of content based on input from a remote control device featuring a touchable display, according to an exemplary embodiment. By way of example, a display associated with a content processing device (e.g., STB 103) presents content 503 via a display 501 to a user. As mentioned before, the content may include broadcasted, televised, pre-recorded, live, streaming media or other media content as provided by way of a media service provider 119. In addition, the content includes interactive content 505—i.e., content embedded within or associated with the televised, broadcasted or otherwise presented content for invoking additional actions and features with respect to the content 503/505. Still, by way of example, content 503 is presented along with various widgets, including a menu or control panel widget 507 and a time widget 509. The menu or control panel widget 507, when activated by user touch or other means, invokes presentment of a menu or control panel that features various control functions of the STB 103 relative to the content 503. The time widget 509, which is positioned atop content 503, presents the current time.

A remote control device 511, implemented by way of example as a tablet PC, iPad™ or other wireless capable device featuring a touchable display is presented. The remote control device operates to present the same content 503, interactive content 505 and widgets 507 and 509 via its touchable display 511 concurrently with display 501 of the STB 103; with the same dimensional characteristics as that displayed to the STB 103. By way of example, touch provided by way of a user's finger 517a making contact with the touchable display of the device 511 or other input means are simulated, mimicked or invoked similarly as if the touchable display 501 was in contact with the user's finger 517a. For the purpose of illustration, an icon 517b representative of the touch point, current motion, pattern, speed and/or position of the user's finger 517a on the display of the remote control device 511 as it corresponds (e.g., translates) to the display 501 of the STB 103 is shown. It is noted that the icon may or may not be rendered to display 501. Of further note, the translation module 223 ensures subsequent touch and characteristics thereof, such as movement of the user's finger 517a from the menu or control panel widget 507 to interactive content 505, is appropriately represented at the display 501. By way of example, if upon touching interactive content 505 at the remote control device 511 the content is invoked to change color, highlight, or standout from the rest of the content 503, this same execution occurs at the STB display 501.

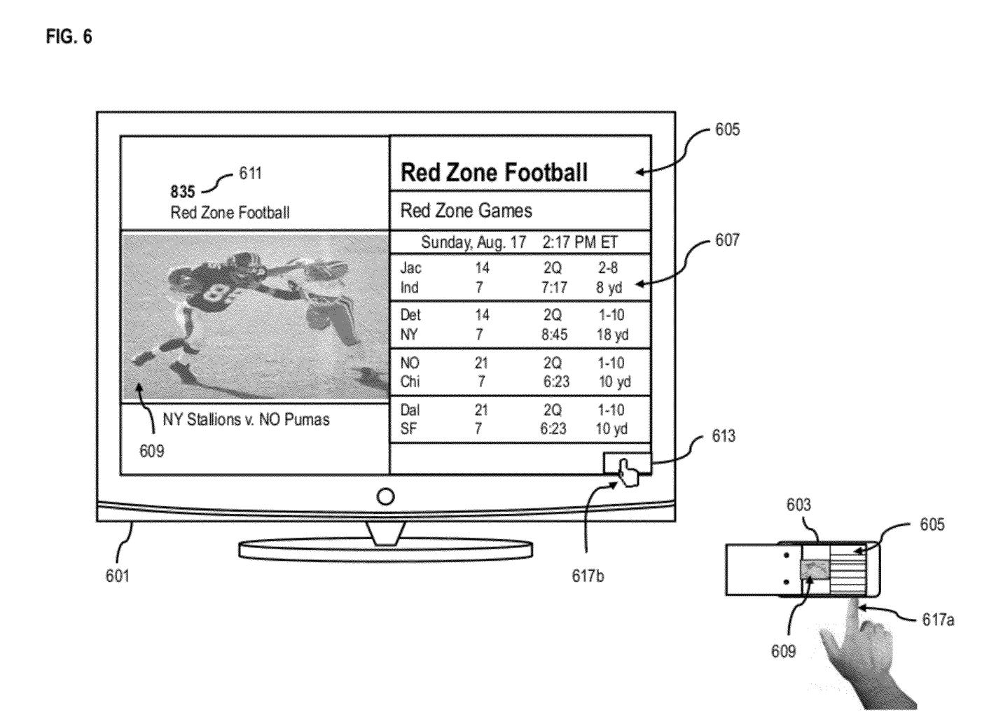

In FIG. 6, a display 601 of a set-top box (not shown) is controlled via a touchable interface of a smartphone device 603. As before, content 605 is presented concurrently to respective displays and touch input generated actions and characteristics, as provided by a user's finger 617a, are mimicked on respective devices (i.e., including STB displays 601 that are non-touchable). Icon 617b represents the touch point, current motion, pattern, speed and/or position of the user's finger 617a on the display of the remote control device 603 as it corresponds (e.g., translates) to the same point on display 601 of the STB 103. By way of example, the content is divided into various frames of content, including a football scoreboard 607, a current game being played between opposing teams 609, a section for specifying the current channel and title of the broadcasted media content 611, etc. It is noted the content as presented in this example, featuring the various sections or frames of content, may be invoked for presentment by activation of the menu or control panel widget 613.

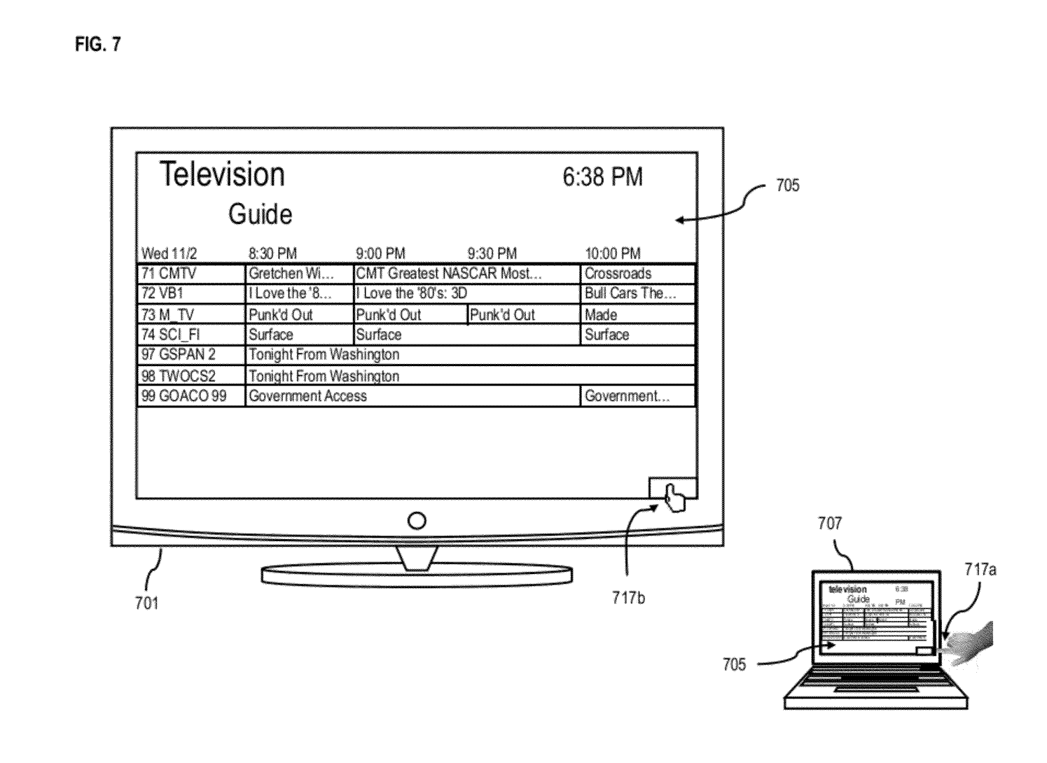

In FIG. 7, a television guide widget 705 is presented as content to the display 701. By way of example, the widget 705 may be activated based on a finger touch 717a presented to a touchable display of a laptop device 707. The touchable display of the laptop presents the widget 705 concurrent with display 701 of the STB. As will be discussed later, the user may provide various inputs at the touchable display of the laptop device 707 for interacting with the widget 705, all of which include particular variations and applications of touch that affect control of the STB or interaction with content presented to the STB display 701. It is noted that for devices featuring non-touchable displays, touchable interaction at the remote control device 707 provides for appropriate control of the STB associated with display 701.

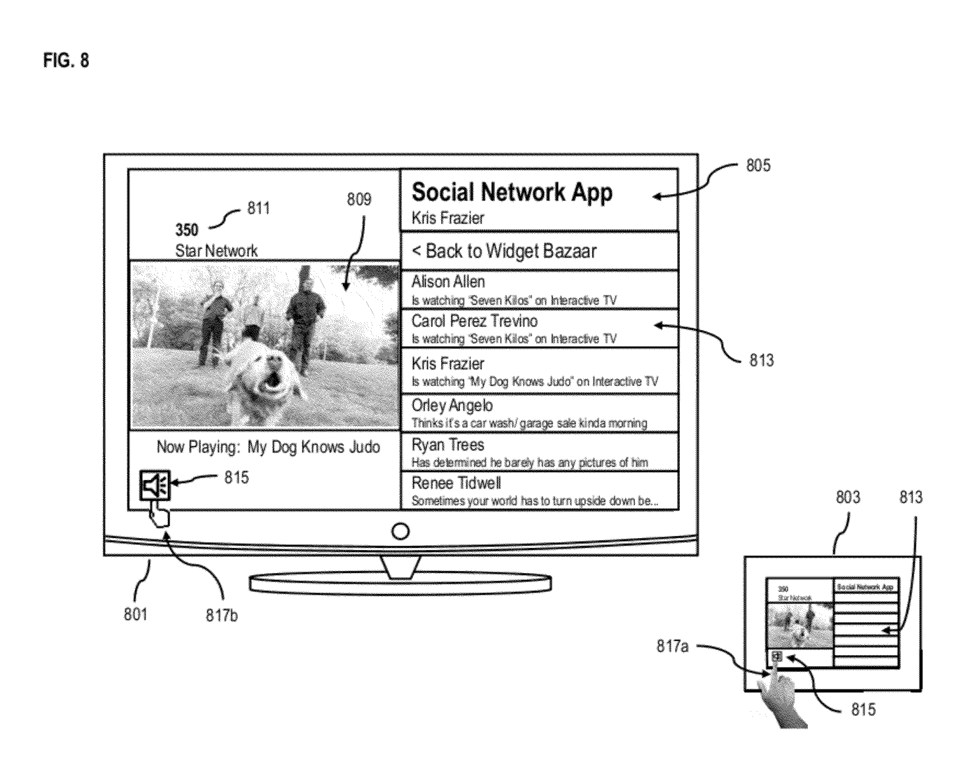

By way of example, a social networking application 805 is presented for execution, i.e., as a social networking widget or webservice, to the display 801 of FIG. 8. Various message threads 813 of friends within the user's social network are presented, including messages indicating what content certain friends are viewing at the moment or custom messages they generated. In addition, a current movie 809 in play is presented along with the current channel and title 811 of the media content 809. Control buttons may also be featured for controlling execution of the content 809 or STB, i.e., a volume control button 815, pause button, record button, etc. When the user touches the volume control button 815 from remote control device (e.g., tablet PC) 803 with finger 817a, an audio control feature of the audio system 209 is invoked and represented to the display 801. The touch point corresponding to the finger 817a is represented by icon 817b. It is noted in this example that varying types of media content are presented for simultaneous execution within the same display 801 and that of the remote control device 803, including web based media, video media and audio media.

It is contemplated that other STB and display operations other than those presented in the exemplary embodiments may be executed via the remote control device of the user. The applications, widgets, control options and functions made available will be based on the capabilities of the remote control device, capabilities of the STB and display being controlled, features offered by the media service provider 119 or combinations thereof. Other operations and services may include enabling of the following:
pop-up menus in a hot spot
TV configuration and setup with fingers
playing music
viewing documents, including presentation slides and text data
accessing weather, stock, traffic, news or really simple syndication (RSS) data
playing games
paying bills
viewing e-mail or short message service (SMS) messages
hosting video conferences (e.g., via existing picture-in-picture technology)
viewing photo albums

For the purpose of illustration, differing variations and applications of touch may be programmatically configured to affect control of the STB or interaction with content presented to a STB display. For non-touchable displays, touch input at the remote control device can be associated with the appropriate control functions of the STB for enabling touch based control at the set-top box 103. This includes:
use of touch to access or operate the above described operations and services
swipe bottom up to top to open or activate widgets, web services or other executables presented as or along with media content
swipe from top to bottom to close or deactivate widgets, web services or other executables presented as or along with media content
two finger swipe slowly to advance to next day (of the same time) of a program featured in a television guide widget
two finger swipe slowly again n times to get next n day (of the same time) of a program featured in a television guide widget
two finger swipe fast to advance to next week (of the same time) of a program featured in a television guide widget
n finger swipe fast again n times to get next n week (of the same time) of a program featured in a television guide widget (by way of example, n may be any amount of fingers, such as, e.g., 1, 2, or 3)
one finger to scroll a television guide or channel listing up or down

Exemplary control signals produced by way of touch for controlling televised or broadcast media content interaction may include a touch for: pausing of content, recording of content, playing of content, display of content, activation of the set-top box, and deactivation of the set-top box.

It is contemplated in future implementations that fingerprint recognition may be associated with touch for enabling enhanced or otherwise restricted access to media or data content. In addition, custom touch signals may be programmed for recognition by the system 100 to enable user specific control functions and STB control customization. Still further, it is contemplated in future implementations that interactive content activated by touch may be coordinated to generate control signals for controlling external devices and appliances through the user premise 113.

The exemplary system and techniques presented herein enable touch based control of display devices via a touchable display of a remote control device. It is of particular advantage that the techniques for enabling a remote control device may be implemented for any set-top box, including those featuring touchable and non-touchable displays. In this way, the remote control device may interact with a set-top box and its associated display by way of any wireless communication link or other signal transmission means. As another advantage, large displays may be suitably controlled and content presented thereon may be interacted with directly from the touchable display of the remote control device. In this way, touch based control and content presentment is executed concurrently by respective devices.

The processes described herein for enabling a user to interact with and control a content processing device using a remote control device having a touch screen may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

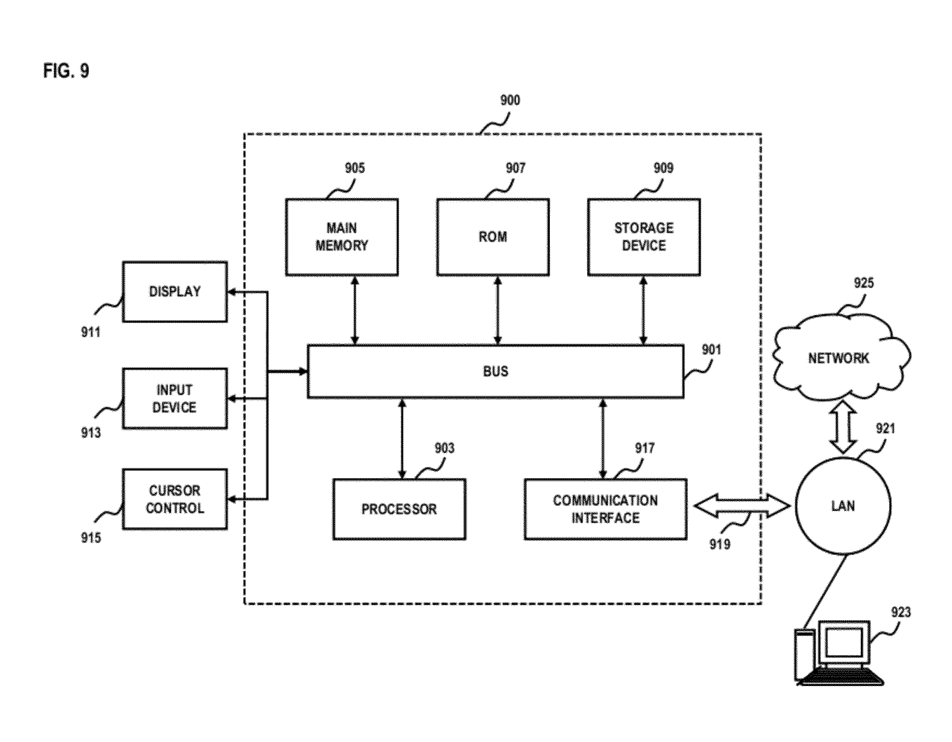

FIG. 9 illustrates computing hardware (e.g., computer system) 900 upon which an embodiment according to the invention can be implemented. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to computer-readable storage media ((or non-transitory media)—i.e., non-volatile media and volatile media), and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

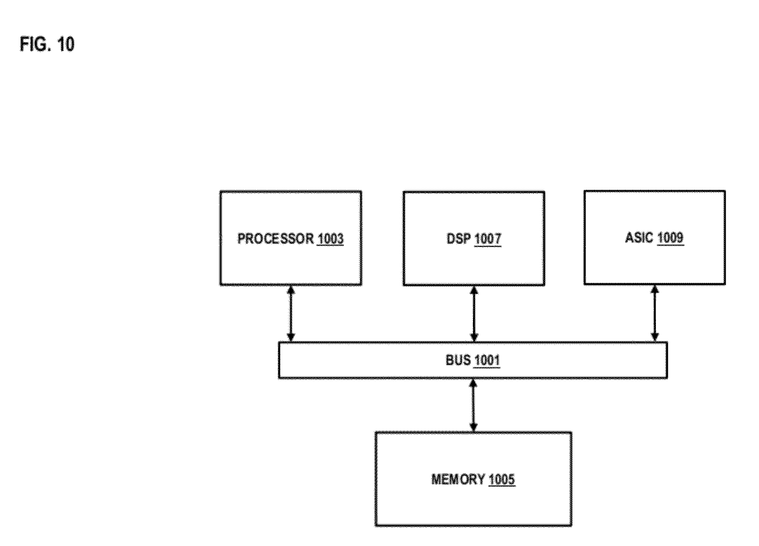

FIG. 10 illustrates a chip set 1000 upon which an embodiment of the invention may be implemented. Chip set 1000 is programmed to present a slideshow as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of FIGS. 3, 4A and 4B.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
presenting content at a remote control device having a touchable display;
receiving a user input via the touchable display of the remote control device; and
generating a control signal, at the remote control device, in response to the user input for controlling a set-top box coupled to a display, wherein the set-top box is configured to present the content on the display concurrently with the touchable display.

2. A method according to claim 1, wherein the display includes a touch screen, and the user input corresponds to an identical control function provided by the touch screen.

3. A method according to claim 1, further comprising:
detecting a single or multiple touch on the touchable display as the user input for generating the control signal.

4. A method according to claim 3, further comprising:
further detecting speed, motion, position or a combination thereof of the touch on the touchable display to generate the control signal.

5. A method according to claim 4, wherein the touch is associated with a swipe across the touchable display to change a broadcast channel presented by the set-top box.

6. A method according to claim 4, wherein the content includes a program guide specifying programs arranged according to a time schedule, and the touch is associated with a swipe across the touchable display to navigate the time schedule of the program guide

7. A method according to claim 1, wherein the control signal corresponds to a playback function associated with the content.

8. A method according to claim 1, wherein the remote control device includes a mobile phone, or a wireless computer.

9. A method according to claim 8, further comprising:
initiating communication, at the remote control device, with the set-top box via a wireless link to transmit the control signal.

10. A remote control apparatus comprising:
a touchable display configured to present content, wherein the touchable display is configured to receive a user input; and
a processor configured to generate a control signal in response to the user input for controlling a set-top box coupled to a display, wherein the set-top box is configured to present the content on the display concurrently with the touchable display.

11. A remote control according to claim 10, wherein the display includes a touch screen, and the user input corresponds to an identical control function provided by the touch screen.

12. A remote control apparatus according to claim 10, wherein the touchable display is further configured to detect a single or multiple touch as the user input for generating the control signal.

13. A remote control apparatus according to claim 12, wherein the touchable display is further configured to detect speed, motion, position or a combination thereof of the touch for generating the control signal by the processor.

14. A remote control apparatus according to claim 13, wherein the touch is associated with a swipe across the touchable display to change a broadcast channel presented by the set-top box.

15. A remote control apparatus according to claim 4, wherein the content includes a program guide specifying programs arranged according to a time schedule, and the touch is associated with a swipe across the touchable display to navigate the time schedule of the program guide.

16. A remote control apparatus according to claim 1, wherein the control signal corresponds to a playback function associated with the content.

17. A remote control apparatus according to claim 1, wherein the apparatus includes a mobile phone or a wireless computer.

18. A remote control apparatus according to claim 8, further comprising:
a transceiver configured to transmit the control signal via a wireless link to the set-top box.

19. A set-top box apparatus comprising:
a communication interface configured to receive a control signal over a wireless local area network from a control device having a touchable display that receives a user input for generating the control signal; and
a presentation module configured to present content to a display according to the control signal, the content being concurrently presented with the touchable display of the remote control device.

20. A method according to claim 1, wherein the display includes a touch screen, and the user input corresponds to an identical control function provided by the touch screen.
